(19) United States
(12) Patent Application Publication
(10) Pub. No.: US 2025/0348374 A1
(43) Pub. Date: Nov. 13, 2025

(54) TEST SUPPORT DEVICE AND TEST SUPPORT METHOD

(71) Applicant: Hitachi, Ltd., Tokyo (JP)

(72) Inventors: Yusuke NISHI, Tokyo (JP); Hideyuki SAKAI, Tokyo (JP); Masaharu UKEDA, Tokyo (JP)

(73) Assignee: Hitachi, Ltd., Tokyo (JP)

(21) Appl. No.: 19/053,657

(22) Filed: Feb. 14, 2025

(30) Foreign Application Priority Data
May 8, 2024 (JP) 2024-075925

(51) Int. Cl. G06F 11/07; G06F 11/00

(52) U.S. Cl. CPC G06F 11/079; G06F 11/008; G06F 11/0709

(57) ABSTRACT

Provided is a test support device capable of designing a fault that matches a microservice state that can change at all times. A processor of a test support device includes: a test execution unit that selects a microservice and a reliability function, which are configured in the test target system and tested for a fault, on the basis of microservice information, and selects a type of fault to be generated in the microservice in a test on the basis of a fault condition; and a fault setting information creation unit that selects a microservice to generate a fault on the basis of microservice state information, determines a setting value of a fault setting item for the microservice and the fault type, and creates fault setting information.

### TECHNICAL FIELD

The present invention relates to a test support device and a test support method.

### BACKGROUND ART

In recent years, in order to enhance corporate competitiveness, transition from a monolithic legacy system to a cloud-native system promoting digital transformation (DX) is in progress. In particular, there is a growing need for microservice architectures in the transition to cloud-native systems.

In the microservice architecture, a large number of small functions called microservices are sparsely linked to perform processing. Therefore, function modification and scaling for each microservice are possible, and flexible and rapid system construction or system modification is possible. On the other hand, there is a problem that the system is divided into smaller functions and the dependence relationship increases as compared with the related art, so that the number of fault points increases.

For example, microservices communicate with each other through an application programming interface (API). However, if the CPU load or the memory load of the microservice of the communication destination increases and the processing takes time, the processing of the microservice of the communication source also takes time. In this way, delay of one microservice may cause delay of many microservices. Compared with a monolithic legacy system, in a microservice architecture, there are many points of fault, such as computer resources in a large number of microservices and a network connecting them.

Conventionally, a fault test in which a user intentionally generates a fault to confirm reliability of a system has been used. In the fault test, a user such as a system engineer confirms that the system normally operates even at the time of fault and that the system recovers. Then, the user enhances reliability of the system by repeating system improvement based on abnormal operation that occurs in the system at the time of fault. However, in the fault test, it is necessary for the user to individually design what fault to generate and manually generate the designed fault, and the man-hour for designing the test is large.

PTL 1 describes that “A fault injection method acquires a fault injection task including at least one target service indicator and a corresponding fault scene. In addition, the target service is specified based on each target service indicator, and the state of the target service is acquired. In a case where the state of the target service is a normal state, a fault scene corresponding to the target service indicator is injected into the target service.”

### CITATION LIST

### Patent Literature

PTL 1: JP 2021-190089 A

### SUMMARY OF INVENTION

### Technical Problem

In the technology for automating a part of a fault in a test described in PTL 1, an indicator for presenting an injection risk of a fault scene is attached to a high risk command and a high risk code segment in the contents of a program, and the fault scene corresponding to each indicator is injected into a target service. However, in the processing of injecting a predetermined fault scene into a predetermined indicator described in PTL 1, it is not possible to generate a flexible and appropriate fault matching the microservice state that can change at all times. This is because an appropriate fault to a microservice state that can change at any time cannot be designed.

The present invention has been made in view of the above problems, and an object of the present invention is to design a fault that matches a microservice state that can change at all times.

### Solution to Problem

A test support device according to the present invention includes a test support device includes a storage unit and a processor. The storage unit includes microservice information including information regarding a reliability function set in a microservice and a value of a setting item set in the reliability function, microservice state information including information regarding a state of the microservice, and a fault condition including information regarding a fault to be generated in the microservice configured in a test target system. The processor includes: a test execution unit that selects the microservice and the reliability function, which are configured in the test target system and tested for a fault, on a basis of the microservice information, and selects a fault type of a fault to be generated in the microservice in the test on a basis of the fault condition; and a fault setting information creation unit that selects the microservice to generate a fault on a basis of the microservice state information, determines a setting value of a fault setting item for the microservice and the fault type, and creates fault setting information.

### Advantageous Effects of Invention

According to the present invention, in designing a fault test for a microservice, a fault matching a microservice state that can change at any time can be designed.

Problems, configurations, and effects other than those described above will be clarified by the following description of embodiments.

### BRIEF DESCRIPTION OF DRAWINGS

FIG. 1 is a diagram illustrating an example of a schematic configuration of a test support system including a test support device according to an embodiment of the present invention.

FIG. 2 is a functional block diagram illustrating an example of a functional configuration of a test support device according to an embodiment of the present invention.

FIG. 3 is a diagram illustrating an example of microservice information according to an embodiment of the present invention.

FIG. 4 is a diagram illustrating an example of microservice state information according to an embodiment of the present invention.

FIG. 5 is a diagram illustrating an example of a fault condition according to an embodiment of the present invention.

FIG. 6 is a diagram illustrating an example of fault setting information according to an embodiment of the present invention.

FIG. 7 is a diagram illustrating an example of a hardware configuration of a test support device according to an embodiment of the present invention.

FIG. 8 is a flowchart illustrating an example of test support processing in a test support device according to an embodiment of the present invention.

FIG. 9 is a flowchart illustrating an example of fault setting information creation processing in a fault setting information creation unit according to an embodiment of the present invention.

FIG. 10 is a flowchart illustrating an example of fault occurrence state confirmation processing performed by a test execution unit according to an embodiment of the present invention.

FIG. 11 is a diagram illustrating how microservice state information changes according to an embodiment of the present invention.

FIG. 12 is a diagram illustrating a display example of a test result display screen according to an embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description is omitted.

### First Embodiment

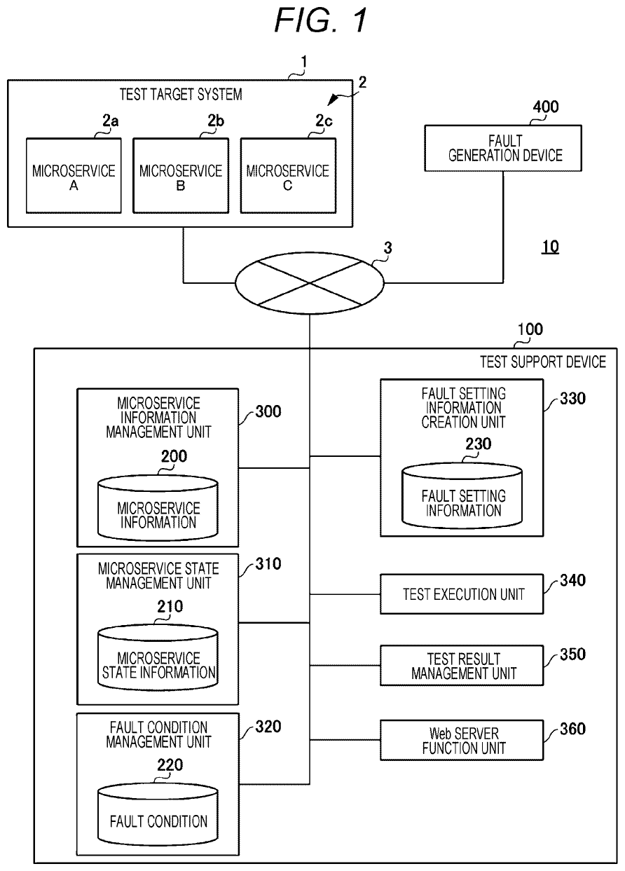

FIG. 1 is a diagram illustrating an example of a schematic configuration of a test support system including a test support device according to an embodiment of the present invention.

A test support system 10 includes a test target system 1, microservices 2a, 2b, and 2c constituting the test target system 1, a test support device 100, and a fault generation device 400. The microservices 2a, 2b, and 2c may be referred to as microservices A, B, and C in the following description. In addition, the microservices 2a to 2c are also referred to as a microservice 2 unless otherwise distinguished.

The test support device 100 is connected to the test target system 1 and the fault generation device 400 via a network 3 so as to be able to communicate with each other. Note that the number of test target systems 1 and microservices 2 is not particularly limited.

The test target system 1 is, for example, a server computer that is physical computer hardware owned by a company. In a general chaotic test, a fault that stops a randomly selected computer resource is often generated. Therefore, it is possible to perform the fault test during the actual operation of the test target system 1. As described above, in the test target system 1, the fault test can be performed either before the actual operation or during the actual operation. Note that, in the chaotic test, since a fault occurs randomly, a fault to be tested may be omitted. On the other hand, since the test support device 100 causes a fault in the computer resource satisfying the fault condition, it is possible to prevent omission of a fault to be tested.

The microservice 2 is a microservice divided for each small function constituting the test target system 1. The microservice 2 is realized by, example, a virtual server computer constructed on physical computer hardware owned by a company.

The network 3 is, for example, a public network such as the Internet, a local area network (LAN), a wide area network (WAN), or the like, and various types of information are transmitted and received between devices and systems.

The fault generation device 400 is, for example, a server computer that is physical computer hardware owned by a company. The fault generation device 400 acquires fault setting information 230 from the test support device 100 and generates a fault in the microservice 2 constituting the test target system 1 using the acquired information.

The test support device 100 includes a microservice information management unit 300, a microservice state management unit 310, a fault condition management unit 320, a fault setting information creation unit 330, a test execution unit 340, a test result management unit 350, and a Web server function unit 360. The microservice information unit management 300 manages microservice information 200. The microservice state management unit 310 manages microservice state information 210. The fault condition management unit 320 manages a fault condition 220. The fault setting information creation unit 330 manages the fault setting information 230.

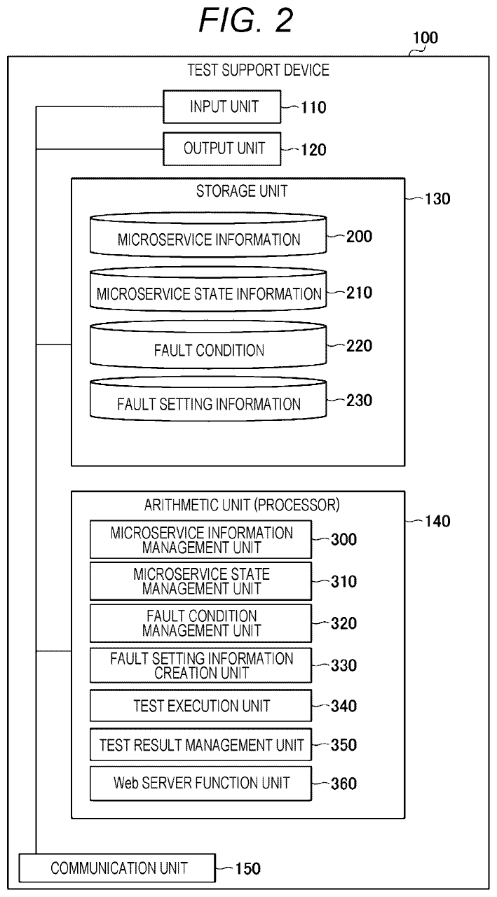

Next, a functional configuration example of the test support device 100 will be described with reference to FIG. 2.

FIG. 2 is a functional block diagram illustrating an example of a functional configuration of the test support device 100.

The test support device 100 includes an input unit 110, an output unit 120, a storage unit 130, an arithmetic unit 140, and a communication unit 150.

The input unit 110 is a functional unit that receives input information. Specifically, the input unit 110 receives user input information input via an input device such as a keyboard or a mouse included in the test support device 100. In addition, the input unit 110 outputs the received input information to the arithmetic unit 140.

The output unit 120 is a functional unit that generates screen information and the like to be displayed on a display device. Specifically, the output unit 120 generates screen information to be displayed on a display device such as a display included in the test support device 100. In addition, the output unit 120 outputs the generated screen information to the display device.

The storage unit 130 is a functional unit that stores various types of information. The storage unit 130 includes, for example, a non-volatile storage medium such as a hard disk drive (HDD), a solid state drive (SSD), an optical disk, a magneto-optical disk, or a non-volatile memory. The storage unit 130 stores a program for realizing a function as the test support device 100 in addition to an operating system (OS) and various parameters. Therefore, the storage unit 130 is used as an example of a non-transitory computer-readable storage medium storing a program to be executed by the test support device 100.

Specifically, the storage unit 130 includes the microservice information 200, the microservice state information 210, the fault condition 220, and the fault setting information 230.

The arithmetic unit 140 includes a processor such as a CPU that reads a software program for realizing each function according to the present embodiment from the storage unit 130 and executes the program. Specifically, the arithmetic unit 140 includes the microservice information management unit 300, the microservice state management unit 310, the fault condition management unit 320, the fault setting information creation unit 330, the test execution unit 340, the test result management unit 350, and the Web server function unit 360.

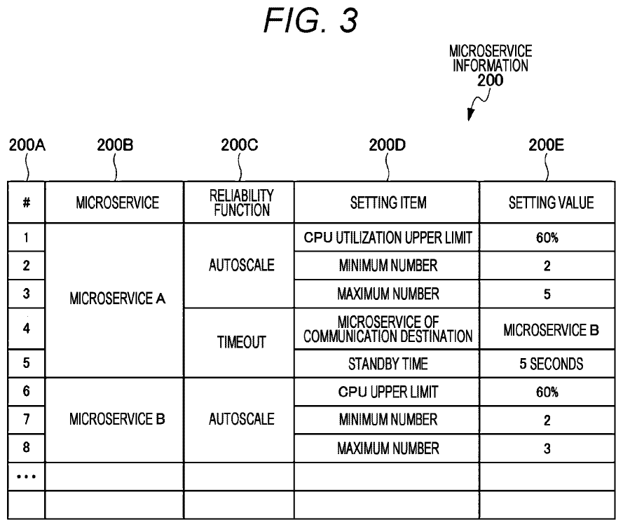

FIG. 3 is a diagram illustrating an example of the microservice information 200. The microservice information 200 is managed by the microservice information management unit 300 illustrated in FIG. 1. The information stored in the microservice information 200 is set, for example, by a user who constructs the test support device 100 according to system requirements.

The microservice information 200 includes a reliability function set for each microservice, a setting item set to realize the reliability function, and information regarding a setting value set in the setting item. Specifically, the microservice information 200 has a record in which information such as a data record ID 200A, a microservice 200B, a reliability function 200C, a setting item 200D, and a setting value 200E is associated.

The data record ID 200A is information indicating an ID of a data record of the microservice information 200.

The microservice 200B is information indicating the microservice 2. For example, the microservices A and B are stored.

The reliability function 200C is information indicating the reliability function set in the microservice 2. For example, autoscale and timeout are stored. Autoscale is a function of automatically increasing the number of resources or increasing specifications when a load of a microservice reaches a predetermined threshold. The timeout is a function of terminating processing and blocking communication in a case where the microservice does not respond even when a predetermined response time is exceeded.

The setting item 200D is information indicating a setting item set to realize the reliability function. For example, when the reliability function is autoscale, a CPU utilization upper limit, a minimum number, and a maximum number are stored. When the reliability function is timeout, the communication destination microservice and the standby time are stored.

The setting value 200E is information indicating a value set in the setting item for realizing the reliability function. For example, 60% is stored in the CPU utilization upper limit. In addition, “2” is stored as the minimum number of computer resources, and “5” is stored as the maximum number of computer resources.

For example, a data record with the data record ID 200A of “1” in FIG. 3 indicates “The CPU utilization upper limit of autoscale which is the reliability function set in the microservice A is 60%.” In addition, the data records with the data record IDs 200A of “1”, “2”, and “3” in FIG. 3 indicate that “In the microservice A, an autoscale function for increasing the number of computer resources up to five is set such that the minimum number of computer resources is two and the CPU utilization rate does not exceed 60%.” as a whole.

Further, the data records with the data record IDs 200A of “4” and “5” in FIG. 3 indicate that “In a case where the communication destination is the microservice B, the microservice A is set with a timeout function of blocking communication when a response exceeds 5 seconds.” as a whole.

Here, the information included the microservice information 200 is not limited to the exemplified information. For example, information of functions such as retry and circuit breaker may be held as the reliability function. In addition, identifier information of a specific service of the communication destination microservice such as a port number may be held as setting items of timeout.

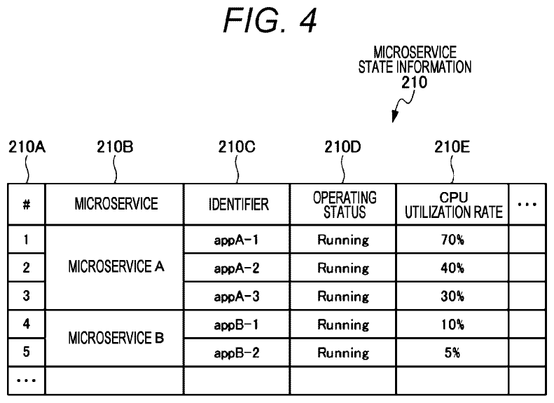

FIG. 4 is a diagram illustrating an example of microservice state information 210. The microservice state information 210 is managed by the microservice state management unit 310 illustrated in FIG. 1. In the microservice state information 210, microservice state information including a current operating status of the microservice, a CPU utilization rate, and the like is recorded.

The microservice an state information 210 includes identifier of a computer resource deployed as the microservice 2, an operation rate of each computer resource, and a utilization rate of a processor (for example, the CPU) used in the computer The utilization rate of each computer resource and the resource. operation rate of the processor used in the computer resource represent information regarding the state of the microservice. Specifically, the microservice state information 210 has a record in which information such as a data record ID 210A, a microservice 210B, an identifier 210C, an operating status 210D, and a CPU utilization rate 210E is associated.

The data record ID 210A is information indicating an ID of a data record of the microservice state information 210.

The microservice 210B is information indicating the microservice 2.

The identifier 210C is information indicating an identifier of a computer resource deployed as the microservice 2. For example, appA-1, appA-2, and appA-3 are allocated as the identifiers.

The operating status 210D is information indicating an operating status of each computer resource of the microservice 2. When the computer resource is in operation, “Running” is stored.

The CPU utilization rate 210E is information indicating the CPU utilization rate of each computer resource of the microservice 2.

For example, a data record with the data record ID 210A of “1” in FIG. 4 indicates “One of the computer resources deployed as the microservice A is an identifier appA-1, the operating status is Running (in normal operation), and the CPU utilization rate is 70%.” Further, the data records with the data record IDs 210A of “1”, “2”, and “3” indicate that “There are three computer resources deployed as the microservice A, and identifiers thereof are appA-1, appA-2, and appA-3.”

Here, the information included in the microservice state information 210 is not limited to the exemplified information. For example, information of computer resources such as a memory utilization rate and a communication amount may be held.

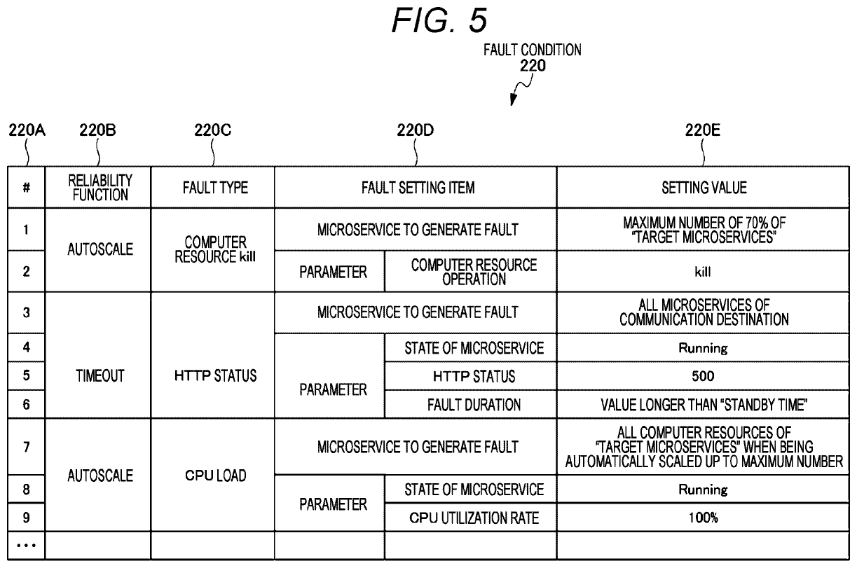

FIG. 5 is a diagram illustrating an example of the fault condition 220. The fault condition 220 is managed by the fault condition management unit 320 illustrated in FIG. 1. The information stored in the fault condition 220 is also set, for example, by the user who constructs the test support device 100 according to the system requirements.

The fault condition 220 includes information regarding a fault that the fault generation device 400 generates in a microservice included in the test target system 1. The fault condition 220 includes a fault type indicating a fault that the fault generation device 400 generates in the microservice for each reliability function, a fault setting item related to the fault, and a setting value set in the fault setting item. Specifically, the fault condition 220 has a record in which information such as a data record ID 220A, a reliability function 220B, a fault type 220C, a fault setting item 220D, and a setting value 220E is associated.

The data record ID 220A is information indicating an ID of a data record of the fault condition 220.

The reliability function 220B is information indicating a reliability function to be tested. Similarly to the microservice information 200, for example, autoscale and timeout are stored.

The fault type 220C is information indicating a fault to be generated in the microservice. For example, information such as a computer resource Kill, a hyper text transfer protocol (HTTP) status, and a CPU load is stored as the fault type. The fault of the computer resource Kill is a fault in which the computer resource stops. For example, a fault that stops a Pod (minimum unit of computer resources such as an OS and a CPU) of the microservice state monitoring tool is assumed.

The fault setting item 220D is information indicating a setting item related to a fault to be generated in the microservice. For example, information such as a microservice and a parameter that cause a fault is stored.

The setting value 220E is information indicating a setting value for a setting item of a fault to be generated in the microservice. For example, information such as a maximum number of 70% of “target microservices” and Kill is stored.

For example, data records with the data record IDs 220A of “1” and “2” in FIG. 5 indicate “In a case where a fault of the computer resource Kill is caused for autoscale, the microservice that causes the fault is the maximum number of computer resources that does not exceed 70% among the microservices for which autoscale is set, and the fault that causes the computer resource Kill is caused.” as a whole.

Further, the data records with the data record IDs 220A of “3”, “4”, “5”, and “6” indicate “In a case where a fault of the HTTP status occurs in response to timeout, the microservice that causes the fault is all the computer resources of the communication destination microservice, and the fault that changes the HTTP status of the response from the computer resource in the Running state to 500 is caused to occur for a time longer than the value of “standby time” that is a timeout setting item.” as a whole. The fault to change the HTTP status to 500 represents a server error response (500 Internal Server Error).

Further, the data records with the data record IDs 220A of “7”, “8”, and “9” indicate “In a case where a fault of the CPU load is caused in autoscale, the microservice that causes the fault is all the computer resources when the microservice for which autoscale is set is automatically scaled to the maximum, and the fault that causes the CPU utilization rate of the computer resource in the running state to be 100% is caused.” as a whole.

Here, the information included in the fault condition 220 is not limited to the exemplified information. For example, various pieces of information such as retry and circuit breaker may be held as the reliability function. In addition, various fault information such as communication delay and exception throw may be held as a fault type. Furthermore, information such as communication delay time and class, method, and exception of a program that causes an exception may be held as fault setting items. In addition, since the fault condition 220 created for a certain microservice (for example, MS A) can be diverted to other microservices (for example, MS B), the number of man-hours for the user to create the fault condition 220 again can be reduced.

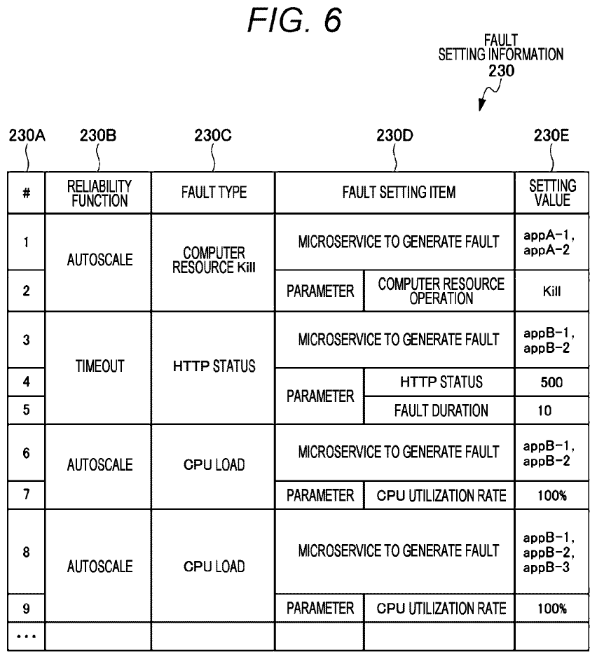

FIG. 6 is a diagram illustrating an example of the fault setting information 230. The fault setting information 230 is created by the fault setting information creation unit 330 illustrated in FIG. 1.

The fault setting information 230 includes information regarding a fault necessary for execution by the fault generation device 400. The fault setting information 230 is associated with a reliability function, a fault type, and a fault setting item, and an identifier of a computer resource of a microservice that generates a fault is set as a setting value of the fault setting item. Specifically, there is a record in which information such as a data record ID 230A, a reliability function 230B, a fault type 230C, a fault setting item 230D, and a setting value 230E is associated.

The data record ID 230A is information indicating an ID of a data record of the fault setting information 230.

The reliability function 230B is information indicating a reliability function to be tested. As the reliability function, for example, autoscale and timeout are stored.

The fault type 230C is information indicating a fault to be generated. In a case where the reliability function 230B of the fault setting information 230 is autoscale, the computer resource kill or the CPU load (an example of the processor load) is associated with the fault type. In a case where the reliability function 230B is timeout, the HTTP status is associated with the fault type.

The fault setting item 230D is information indicating a setting item related to a fault to be generated. As the fault setting item, for example, a microservice that causes a fault and a parameter are stored.

The setting value 230E is information indicating a setting value for a setting item of a fault to be caused. For example, appA-1 and appA-2, which are identifiers of computer resources of a microservice that causes a fault, are stored as the setting values.

For example, data records with the data record IDs 230A of “1” and “2” in FIG. 6 indicate “A fault to kill computer resources is generated for appA-1 and appA-2.” as a whole. In addition, data records with the data record IDs 230A of “3”, “4”, and “5” indicate “A fault in which appB-1 and appB-2 return response of the HTTP status 500 is caused to occur for 10 seconds.” as a whole. Further, data record IDs 230A of “6” and “7” indicates “A fault in which the CPU utilization rate is 100% is caused to occur for appB-1 and appB-2.” as a whole.

Here, the information included in the fault setting information 230 is not limited to the exemplified information. For example, various pieces of information such as retry and circuit breaker may be held as the reliability function. In addition, various fault information such as communication delay and exception throw may be held as a fault type. Further, the fault setting information 230 may hold, as fault setting items, information such as a communication delay time, a class, a method, and an exception of a program that causes an exception, a namespace name in which a microservice is deployed, and a target port number that causes a fault.

Returning to FIG. 2, the description will be given. The arithmetic unit 140 includes a microservice information management unit 300, a microservice state management unit 310, a fault condition management unit 320, a fault setting information creation unit 330, a test execution unit 340, a test result management unit 350, and a Web server function unit 360.

The microservice information management unit 300 is a functional unit that collects and holds the microservice information 200. For example, the microservice information management unit 300 collects information necessary for the microservice information 200 by analyzing the program code acquired from the user. The microservice information management unit 300 executes execution processing of a microservice acquired from the user. In this manner, the microservice information management unit 300 executes the microservice and collects information necessary for the microservice information 200 by the setting value acquisition function provided in advance in the program.

The information necessary for the microservice information 200 is, for example, information such as the setting value 200E of the setting item illustrated in the microservice information 200 of FIG. 3. For example, since there is a portion in which the setting value of autoscale is described in the program code, the microservice information management unit 300 can analyze (parse) this description portion to collect the setting value.

The microservice state management unit 310 is a functional unit that collects and holds the microservice state information 210. For example, the microservice state management unit 310 periodically collects information necessary for the microservice state information 210 by using a microservice state monitoring function provided by a microservice state monitoring tool that is an orchestration tool of a microservice. For the information necessary for the microservice state information 210, for example, in the microservice state monitoring tool, the state of the microservice can be acquired by a command using various command line interfaces (CLIs). In addition, even a commercial monitoring tool can acquire information necessary for the microservice state information 210.

The fault condition management unit 320 is a functional unit that collects and holds the fault condition 220. For example, when the user registers necessary information in the fault condition 220 using the Web server function unit 360, the fault condition management unit 320 collects the fault condition 220.

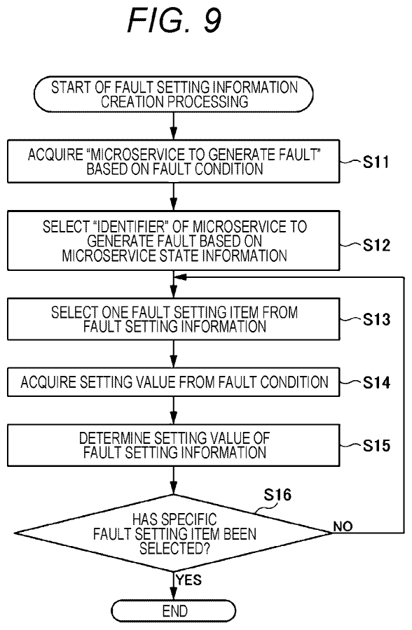

The fault setting information creation unit 330 is functional unit that creates and holds the fault setting information 230. The fault setting information creation unit 330 selects a microservice in which a fault occurs on the basis of the microservice state information 210, determines setting values of fault setting items for the microservice and the fault type, and creates the fault setting information 230. Specifically, the fault setting information creation unit 330 creates the fault setting information 230 using the microservice information 200, the microservice state information 210, and the fault condition 220. Details of the process of creating the fault setting information by the fault setting information creation unit 330 will be described later with reference to FIG. 9.

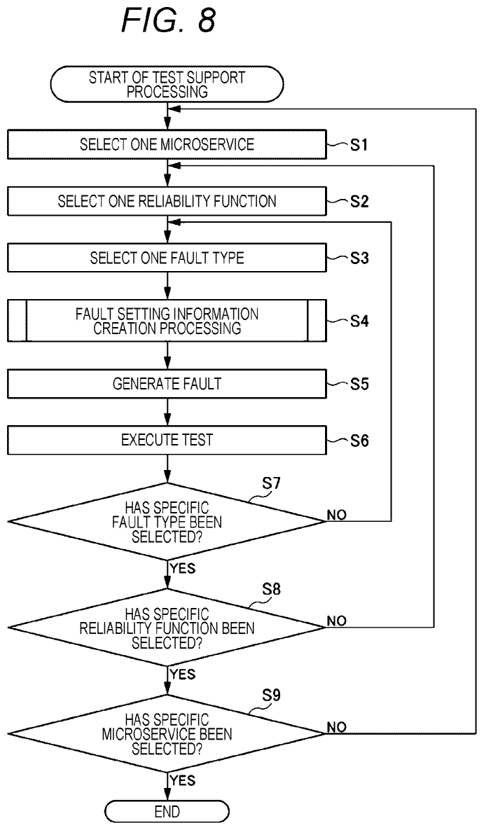

The test execution unit 340 is a functional unit that executes a fault test using the fault setting information 230. For example, the test execution unit 340 generates a fault by executing the fault generation device 400 using the fault setting information 230. Therefore, as illustrated in FIG. 8 to be described later, the test execution unit 340 selects a microservice and a reliability function, which are configured in the test target system 1 and tested for a fault, on the basis of the microservice information 200, and selects a fault type of a fault to be generated in the microservice in the test on the basis of the fault condition 220. After a fault occurs in the microservice, the test execution unit 340 executes the test target system 1 to test the behavior of the test target system 1 at the time of fault.

The test result management unit 350 is a functional unit that collects and holds test results. The test result management unit 350 collects, for example, information such as an execution time and an error log of the test target system 1 at the time of fault using a technology such as a microservice state monitoring tool. A display example of the test result collected and held by the test result management unit 350 will be described later.

The Web server function unit 360 is a function unit that manages input, output, and processing of the test support device 100. For example, the Web server function unit 360 accepts a request for test support from the user, creates the fault setting information 230 in cooperation with each function unit, executes a test, and outputs a test result to the user.

The communication unit 150 is a functional unit that transmits and receives information to and from an external device. Specifically, the communication unit 150 acquires the fault condition 220 from the user, transmits the fault setting information 230 to the fault generation device 400 to generate a fault in the test target system 1, or executes the test target system 1 to test the behavior at the time of fault. As the external device, a personal computer (PC) used by a user, the fault generation device 400, and the test target system 1 are assumed.

The configuration example and the operation example of the functional blocks of the test support device 100 have been described above.

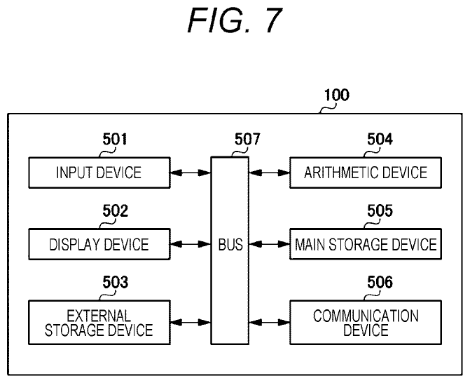

FIG. 7 is a diagram illustrating an example of a hardware configuration of the test support device 100. The test support device 100 is realized by, for example, a server computer which is physical computer hardware.

The test support device 100 includes an input device 501, a display device 502, an external storage device 503, an arithmetic device 504, a main storage device 505, a communication device 506, and a bus 507 that electrically interconnects these devices.

The input device 501 is a keyboard, a mouse, a pointing device such as a touch panel, a microphone which is a voice input device, or the like.

The display device 502 is a display that displays a screen, a speaker that is a voice output device, or the like.

The external storage device 503 is a non-volatile storage device such as a so-called hard disk drive, a solid state drive (SSD), or a flash memory capable of storing digital information. The external storage device 503 is used as an example of a non-transitory computer-readable storage medium storing a program to be executed by the test support device 100.

The arithmetic device 504 is, for example, a central processing unit (CPU). The function of each functional block of the arithmetic unit 140 illustrated in FIG. 2 is realized by the arithmetic device 504.

The main storage device 505 is a memory device such as a random access memory (RAM) or a read only memory (ROM).

The communication device 506 is a wired communication device that performs wired communication via a network cable or a wireless communication device that performs wireless communication via an antenna. The communication device 506 performs information communication with an external device connected to a network.

Note that the arithmetic unit 140 of the test support device 100 is realized by a program that causes the arithmetic device 504 to perform processing. This program is stored in the main storage device 505 or the external storage device 503, loaded on the main storage device 505 when the program is executed, and executed by the arithmetic device 504. In addition, the storage unit 130 of the test support device 100 is realized by the main storage device 505, the external storage device 503, or a combination thereof. Furthermore, the communication unit 150 is: realized by the communication device 506. However, the hardware configuration of the test support device 100 is not limited to the above-described configuration.

Each of the above-described configurations, functions, processing units, and the like of the test support device 100 may be realized by hardware by designing a part or all of them with, for example, an integrated circuit. In addition, the above-described configurations and functions may be realized by software by a processor which constitutes the arithmetic unit 140, interprets and executes a program for realizing each function. Information such as a program, a table, and a file for realizing each function can be stored in a storage device such as a memory, a hard disk, and an SSD, or a recording medium such as an IC card, a card-type storage medium, and a DVD.

In addition, the hardware configuration of the test support device 100 is not limited thereto, and may be configured using other hardware. For example, it may be a device that receives input and output via the Internet. Although not illustrated, the test support device 100 has known elements such as an operating system (OS), middleware, and an application, and has an existing processing function for displaying a GUI screen on an input/output device such as a display.

The hardware configuration of the test support device 100 has been described above.

FIG. 8 is a flowchart illustrating an example of test support processing in the test support device 100. The test support processing is executed, for example, in a case where an instruction to execute the processing is received from the user via the input unit 110. For example, in the test support device 100 according to the present embodiment, the user designates the start of the test by an operation such as pressing a test start button (not illustrated) by the user. When receiving the designation of the test start by the user via the input unit 110, the test execution unit 340 starts the following processing.

When the test support processing is started, the test execution unit 340 of the test support device 100 illustrated in FIG. 1 selects one microservice to be tested from the microservice information 200 (S1). Specifically, the test execution unit 340 selects “microservice A” from the microservice 200B.

Next, the test execution unit 340 selects one reliability function to be tested from the microservice information 200 (S2). Specifically, the test execution unit 340 selects “autoscale” from the reliability function 200C.

Next, the test execution unit 340 selects one fault type to be generated in the test from the fault condition 220 (S3). (Specifically, in a case where autoscale is selected as the reliability function to be tested in step S2, the reliability function 220B selects the computer resource Kill from the fault type 220C among autoscale records.

Next, the fault setting information creation unit 330 performs fault setting information creation processing (S4). In the fault setting information creation processing, the fault setting information creation unit 330 creates the fault setting information 230 using the microservice information 200, the microservice state information 210, and the fault condition 220. Specifically, the fault setting information creation unit 330 determines the value of the setting value 230E of the fault setting information 230. Details of the fault setting information creation processing will be described later with reference to FIG. 9.

Next, the test execution unit 340 transmits the fault setting information 230 to the fault generation device 400 and executes the fault setting information to cause a fault in the test target system 1 (S5).

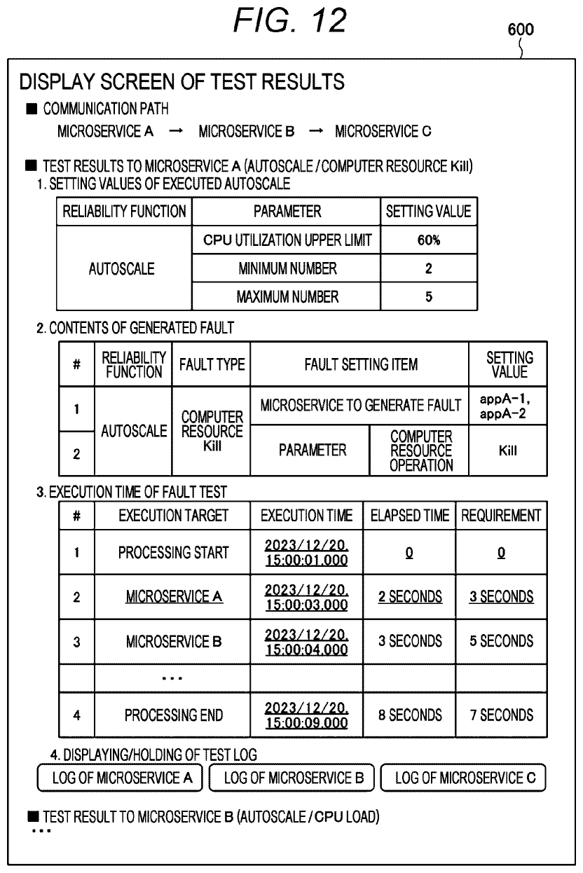

Next, the test execution unit 340 executes a test on the test target system 1 (S6). Note that the execution procedure of the test on the test target system 1 has been registered in advance by the user. When the behavior of the test target system 1 at the time of fault by the test execution unit 340 is tested, the test result management unit 350 collects, holds, and displays the test result (S6). Specifically, the test result management unit 350 collects the execution time of each microservice, the execution log at the normal time, and the error log at the abnormal time as the test result, and stores the collected information in the storage unit 130. In addition, the test result management unit 350 displays the test result on a test result display screen 600 illustrated in FIG. 12 to be described later.

Note that the information collected by the test execution unit 340 as a test result is not limited to the illustrated information. Furthermore, the information collected as a test result by the test execution unit 340 may be information collected by a device (not illustrated) that monitors the state of other microservices.

Next, the test execution unit 340 selects a specific fault type in step S3 and determines whether the test has been performed (S7). In step S7, for example, it is determined whether the computer resource kill and the CPU load are selected from the fault types 220C of the fault condition 220 in FIG. 5 and tested.

In a case where the test execution unit 340 determines that a specific fault type is not selected (NO in S7), the process proceeds to step S3. On the other hand, in a case where the test execution unit 340 determines that a specific fault type has been selected (YES in S7), the test execution unit 340 proceeds to step S8.

Next, the test execution unit 340 selects a specific reliability function in step S2 and determines whether the specific reliability function has been tested (S8). In step S8, for example, it is determined whether autoscale has been selected and tested among the reliability functions 220B of the fault condition 220 in FIG. 5.

In a case where the test execution unit 340 determines that a specific reliability function is not selected (NO in S8), the process proceeds to step S2. On the other hand, in a case where the test execution unit 340 determines that a specific reliability function is selected (YES in S8), the process proceeds to step S9.

Next, the test execution unit 340 selects a specific microservice in step S1 and determines whether the microservice has been tested (S9). In a case where it is determining that a specific microservice is not selected (NO in S9), the test execution unit 340 proceeds to step S1. On the other hand, in a case where it is determined that a specific microservice is selected (YES in S9), the test execution unit 340 ends the processing of this flowchart.

The test execution unit 340 may execute a test covering all fault types for all reliability functions of all microservices. In this case, since there is no fault omission, a sufficient test can be performed. Alternatively, as illustrated in FIG. 8, the test execution unit 340 may execute a test covering a specific fault type for a specific reliability function of a specific microservice selected in advance. In this case, since only the microservice in which the user wants to generate the fault is limited, the user can easily confirm the vulnerability of the test target system 1 to the specific event.

FIG. 9 is a flowchart illustrating an example of fault setting information creation processing in the fault setting information creation unit 330. Such processing is executed in step S4 of FIG. 8.

When the fault setting information creation processing is started, the fault setting information creation unit 330 acquires a value of “a microservice that generates a fault” based on the fault condition 220 (S11). Specifically, in a case where the test execution unit 340 selects to test the computer resource Kill for autoscale of the microservice A in steps S1, S2, and S3, “the maximum number of 70% of ‘target microservices’” is acquired from the setting value 220E of the fault condition 220 as a microservice that generates a fault.

Next, the fault setting information creation unit 330 selects an identifier of a microservice that generates a fault based on the value of the “microservice that generates a fault” acquired in step S11 and the microservice state information 210 (S12). Specifically, the fault setting information creation unit 330 acquires that the microservice A has three computer resources of the identifiers appA-1, appA-2, and appA-3 deployed on the basis of the identifier 210C of the microservice state information 210.

Here, the fault setting information creation unit 330 determines to select the maximum number of 3×70%=2.1, that is, 2 computer resources on the basis of the “maximum number of 70% of the ‘target microservices’” acquired in step S11. At this time, the fault setting information creation unit 330 may randomly select two computer resources as a method of selecting two computer resources from appA-1, appA-2, and appA-3. In addition, for example, the fault setting information creation unit 330 may select two microservices from microservices having high CPU utilization rate on the basis of the CPU utilization rate 210E of the microservice state information 210, or may select the microservices by a predetermined arbitrary method.

Next, the fault setting information creation unit 330 selects one fault setting item for generating a fault on the basis of the fault setting information 230 (S13). Specifically, “computer resource operation” is selected as the parameter of the fault setting item corresponding to “Kill” of the computer resource for autoscale from the fault setting item 230D of the data record with the data record ID 230A of “2” of the fault setting information 230.

Next, the fault setting information creation unit 330 acquires a setting value for generating a fault on the basis of the fault condition 220 (S14). Specifically, the fault setting information creation unit 330 acquires “Kill” from the fault condition 220 as a setting value of the computer resource operation which is the fault setting item of the computer resource for autoscale.

Next, the fault setting information creation unit 330 determines a setting value of the fault setting information 230 for generating a fault in the test target system 1 (S15). Specifically, the fault setting information creation unit 330 determines “Kill” which is the setting value of the computer resource operation acquired in step S14 as the setting value for generating the fault.

Here, in step S15, the fault setting information creation unit 330 may determine the setting value by a predetermined arbitrary method using the microservice information 200 and the microservice state information 210. For example, the fault setting information creation unit 330 selects to generate a fault of the HTTP status in response to timeout of the microservice A in steps S1, S2, and S3, and selects to determine the setting value of the fault duration in step S13. At this time, the fault setting information creation unit 330 acquires “a value longer than ‘standby time’” as the fault duration from the fault condition 220 in step S14. Therefore, in step S15, the fault setting information creation unit 330 determines a value longer than 5 seconds from the data record in which the data record 200A of the microservice information 200 is “5”.

The fault setting information creation unit 330 may determine a value that is twice the standby time, for example, as to how many seconds the fault duration is to be determined. Alternatively, the fault setting information creation unit 330 may determine the fault duration in consideration of a trade-off between prolongation of the test time by the setting time and improvement of the test execution reliability.

Next, the fault setting information creation unit 330 determines whether a specific fault setting item has been selected in step S13 (S16). In a case where it is determined that a specific fault setting item is not selected (NO in S16), the fault setting information creation unit 330 proceeds to step S13. In a case where it is determined that a specific fault setting item has been selected (YES in S16), the fault setting information creation unit 330 ends the processing of this flowchart.

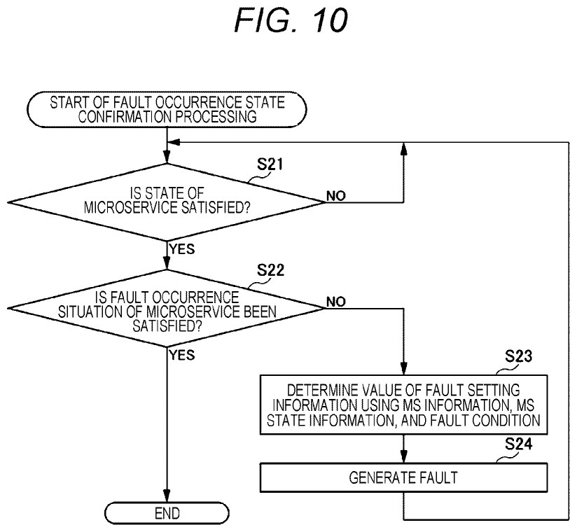

FIG. 10 is a flowchart illustrating an example of fault occurrence state confirmation processing performed by the test execution unit 340. The fault occurrence state confirmation processing may be performed by the test execution unit 340 before executing step S6 and after executing step S5. Alternatively, the fault occurrence state confirmation processing may be performed after all the test support processing of FIG. 8 is completed.

When the fault occurrence state confirmation processing is started, the test execution unit 340 determines whether the state of the microservice satisfies the fault condition 220 based on the microservice state information 210 (S21). In a case where it is determined that the state of the microservice does not satisfy the fault condition (NO in S21), the test execution unit 340 waits until the state of the microservice satisfies the fault condition 220. Therefore, the test execution unit 340 repeats step S21.

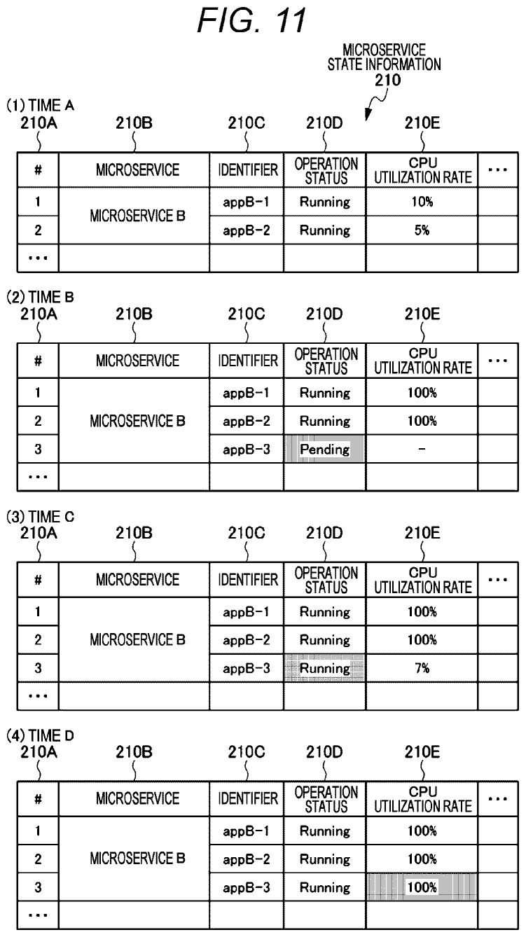

In a case where it is determined that the state of the microservice satisfies the fault condition (YES in S21), the test execution unit 340 proceeds to step S22. Specifically, processing when the test execution unit 340 selects that the CPU load fault occurs in the autoscale function of the microservice B in steps S1, S2, and S3 will be described with reference to FIG. 11 illustrating an example of the microservice state information 210.

FIG. 11 is a diagram illustrating how the microservice state information 210 changes. Hereinafter, the fault occurrence state confirmation processing will be described together with the change in the microservice state information 210 in the order of times A to D.

### (1) Time A

In step S4, the fault setting information creation unit 330 of the test support device 100 uses time A of the microservice state information 210 and the fault condition 220 to create the fault setting information 230 indicating that “A fault with the CPU utilization rate of 100% occurs in appB-1 and appB-2” as indicated by the data records with the data record IDs 230A of “6” and “7” in the fault setting information 230. The test execution unit 340 causes a fault in the test target system 1 based on the fault setting information 230 in step S5.

### (2) Time B

Next, in step S21, the test execution unit 340 acquires “the state of the microservice being Running” from the data record with the data record ID 220A of the fault condition 220 of “8”. The test execution unit 340 determines whether the microservice state information 210 at time B indicating the state of the microservice at the time when the information is acquired from the data record is satisfied. At this time, since appB-3 is in a “Pending” state, the test execution unit 340 determines that the state of the microservice does not satisfy the fault condition, and repeats step S21.

Here, the test execution unit 340 may repeat step S21 after waiting for a certain period of time, or may repeat step S21 after performing the process of solving the Pending state.

### (3) Time C

Next, the test execution unit 340 acquires information of the microservice state information 210 at time C indicating the state of the microservice at that time, and determines whether the state of the microservice satisfies the fault condition. At this time, since all of appB-1, appB-2, and appB-3 are Running, it is determined that the state of the microservice satisfies the fault condition.

Next, the test execution unit 340 determines whether the fault occurrence situation of the microservice satisfies the fault condition 220 on the basis of the microservice state information 210 (S22).

In a case where it is determined that the fault occurrence situation of the microservice does not satisfy the fault condition (NO in S22), the test execution unit 340 proceeds to step S23. In a case where it is determined that the fault occurrence situation of the microservice satisfies the fault condition (YES in S22), the test execution unit 340 ends the processing of this flowchart.

Specifically, the test execution unit 340 acquires “All the computer resources of the ‘target microservices’ when being automatically scaled up to the maximum number are at the CPU utilization rate of 100%.” from the data records in which the data record 210A of the fault condition 220 is “7” or “9”. In addition, the test execution unit 340 acquires the information of the microservice state information 210 at time C indicating the state of the microservice at the time when the information is acquired, and determines whether the fault occurrence situation of the microservice satisfies the fault condition. At this time, since the CPU utilization rate of appB-3 is not 100%, the test execution unit 340 determines that the fault occurrence situation of the microservice does not satisfy the fault condition.

Next, the fault setting information creation unit 330 creates the fault setting information 230 using the microservice information 200, the microservice state information 210, and the fault condition 220 (S23). In step S23, the processing described in step S4 is executed. A difference between steps S4 and S23 will be described. Specifically, the fault setting information creation unit 330 acquires information from the microservice state information 210 at time C indicating the state of the microservice at the time when the information is acquired. The fault setting information 230 indicating that “A fault of the CPU utilization rate 100% is generated in appB-1, appB-2, and appB-3” is created as data records with the data record IDs 230A of “8” and “9” of the fault setting information 230.

Next, the test execution unit 340 causes the fault setting information creation unit 330 to generate a fault in the microservice on the basis of the value of the fault setting information 230 determined using the microservice information 200, the microservice state information 210, and the fault condition 220 (S24). After step S24, the process returns to S21 again to perform processing in which the test execution unit 340 determines whether the state of the microservice satisfies the fault condition. Specifically, the test execution unit 340 transmits the fault setting information 230 to the fault generation device 400 and executes the fault generation device 400 to cause a fault in the microservice of the test target system 1. In this step S24, the processing described in step S5 is executed.

### (4) Time D

Next, the test execution unit 340 repeats the determination processing of the fault requirement in step S21 until the determination in step S22 becomes YES. Specifically, in step S22, the test execution unit 340 acquires information of the microservice state information 210 at time D indicating the state of the microservice at the time when the determination processing is performed. In a case where the test execution unit 340 determines that the fault condition of “A fault of the CPU utilization rate 100% is generated in appB-1, appB-2, and appB-3” is satisfied, the processing of this flowchart is ended. Note that the test execution unit 340 may end the fault test by determining that the fault test cannot be executed depending on the state of the microservice.

FIG. 12 is a diagram illustrating a display example of the test result display screen 600. The test result display screen 600 is displayed by the test result management unit 350 of the test support device 100 after the test support processing illustrated in FIG. 8.

The test result display screen 600 displays the communication path obtained from the microservice information 200, the setting value for each parameter of the reliability function to be executed, and the fault setting information created in step S5. In addition, on the test result display screen 600, as a result of the test executed in step S6, information regarding the fault test such as the execution time of the processing of the microservice, the elapsed time, and access information to the execution log (in the drawing, test log and display) is displayed. The user can display or save the execution log for each microservice by clicking a link button indicated as access information to the execution log.

Note that the information displayed on the test result display screen 600 is not limited to the information illustrated in FIG. 12. For example, the execution time of the fault test and the performance requirement of the processing may be compared and displayed, or statistical information obtained by aggregating a large number of test results such as which microservice is often abnormally terminated when a fault occurs the most or which fault content is often abnormally terminated when a fault occurs the most may be displayed.

In a case where a fault test of a system including a large number of microservices is performed, the test support device 100 according to the embodiment described above can design a flexible and appropriate fault matching the microservice state that can change at all times, and generate a fault in the microservice of the test target system 1. Since the test support device 100 comprehensively generates a fault for a specific microservice, a specific reliability function, and a specific fault type and executes a test, it is possible to enhance reliability of the test target system 1 with respect to the microservice 2.

Conventionally, when a microservice test is executed, a user selects microservices one by one and performs a necessary test, so that there are very many work man-hours. On the other hand, by using the microservice information, the microservice state information, and the fault condition, the test support device 100 according to an embodiment can reduce the number of work man-hours, determine the microservice that causes the fault, and determine the content of the fault to occur. As described above, the test support device 100 can perform a test targeting all of the reliability functions 200C illustrated in FIG. 3 or targeting only a necessary portion, and can prevent omission of the test.

In the test target system 1, a process of performing a specific test for a specific microservice and a specific reliability function flows only by the user designating the start of the test. For this reason, in the conventional test execution method, compared to a case where the user selects microservices one by one and performs a necessary test, the number of work man-hours of the user is significantly reduced in the test using the test support device 100 according to the present embodiment.

Note that the test support device 100 may start specifying which test is to be performed for which reliability function of which microservice as another pattern. In this case, it is possible to test an item that the user wants to test intensively on the test target system 1.

In addition, by determining whether the state of the microservice satisfies the condition of the fault desired to occur and whether the fault occurrence situation of the microservice satisfies the condition of the fault desired to occur, the number of work man-hours by the user is reduced, and the fault test can be executed at an appropriate timing. Furthermore, by displaying the information of the generated fault and the test result, it is possible to confirm the result of the fault test with a small number of work man-hours and to implement improvement for improving the reliability of the system in response to the test result.

Further, the present invention is not limited to the above-described embodiments, and it goes without saying that various other application examples and modifications can be taken without departing from the gist of the present invention described in the claims.

For example, in the above-described embodiment, the configurations of the system have been described in detail and specifically in order to describe the present invention in an easy-to-understand manner, and the present invention is not necessarily limited to those including all the described configurations. In addition, it is also possible to add, delete, and replace other configurations for a part of the configuration of the embodiment.

Further, control lines and information lines are described in consideration of necessity for the description, and all control lines and information lines in the product are not necessarily described. It may be considered that almost all the components are connected to each other in actual.

### REFERENCE SIGNS LIST

1 test target system
2 microservice
10 test support system
100 test support device
200 microservice information
210 microservice state information
220 fault condition
230 fault setting information
300 microservice information management unit
310 microservice state management unit
320 fault condition management unit
330 fault setting information creation unit
340 test execution unit
350 test result management unit
400 fault generation device
600 test result display screen

1. A test support device comprising:
a storage unit; and
a processor, wherein
the storage unit includes microservice information including information regarding a reliability function set in a microservice and a value of a setting item set in the reliability function, microservice state information including information regarding a state of the microservice, and a fault condition including information regarding a fault to be generated in the microservice configured in a test target system, and
the processor includes:
a test execution unit that selects the microservice and the reliability function, which are configured in the test target system and tested for a fault, on a basis of the microservice information, and selects a fault type of a fault to be generated in the microservice in the test on a basis of the fault condition; and a fault setting information creation unit that selects the microservice to generate a fault on a basis of the microservice state information, determines a setting value of a fault setting item for the microservice and the fault type, and creates fault setting information.

2. The test support device according to claim 1, wherein the test execution unit determines whether the state of the microservice satisfies the fault condition on a basis of the microservice state information, and waits until the state of the microservice satisfies the fault condition in a case where it is determined that the state of the microservice does not satisfy the fault condition.

3. The test support device according to claim 2, wherein in a case where it is determined that the state of the microservice satisfies the fault condition, the test execution unit determines whether a fault occurrence situation of the microservice satisfies the fault condition on a basis of the microservice state information, and in a case where it is determined that the fault occurrence situation of the microservice does not satisfy the fault condition, the fault setting information creation unit generates a fault in the microservice on a basis of a value of the fault setting information determined by using the microservice information, the microservice state information, and the fault condition, and the test execution unit determines again whether the state of the microservice satisfies the fault condition.

4. The test support device according to claim 3, wherein the test execution unit executes a test covering all fault types for all the reliability functions of all the microservices, or executes a test covering a specific fault type for a specific reliability function of a specific microservice selected in advance.

5. The test support device according to claim 4, wherein the microservice information includes a reliability function set for each microservice, a setting item set to realize a reliability function, and a setting value set in the setting item, the microservice state information includes an identifier of a computer resource deployed as a microservice, an operation rate of each of the computer resources, and a utilization rate of a processor used in the computer resource, and
the fault condition includes a fault type indicating a fault to be generated in the microservice for each of the reliability functions, a fault setting item related to a fault, and a setting value set in the fault setting item.

6. The test support device according to claim 5, wherein the fault setting information is associated with the reliability function, the fault type, and the fault setting item, and an identifier of the computer resource of the microservice that generates the fault is set as a setting value of the fault setting item.

7. The test support device according to claim 5, wherein in a case where the reliability function of the fault setting information is autoscale, a computer resource kill or a processor load is associated with the fault type, and in a case where the reliability function is timeout, an HTTP status is associated with the fault type.

8. A test support method performed by a test support device including a storage unit and a processor, the storage unit including microservice information including information regarding a reliability function set in a microservice and a value of a setting item set in the reliability function, microservice state information including information regarding a state of the microservice, and a fault condition including information regarding a fault to be generated in the microservice configured in a test target system, the test support method comprising:
selecting, by a test execution unit included in the processor, the microservice and the reliability function, which are configured in the test target system and tested for a fault, on a basis of the microservice information, and selecting a fault type of a fault to be generated in the microservice in the test on a basis of the fault condition; and
selecting, by a fault setting information creation unit included in the processor, the microservice in which a fault occurs on a basis of the microservice state information, determining a setting value of a fault setting item for the microservice and the fault type, and creating fault setting information.
